(19) United States
(12) Patent Application Publication
(10) Pub. No.: US 2022/0282435 A1
(43) Pub. Date: Sep. 8, 2022

(54) SAND SHIELD MADE OF COMBINED POLYMER STABILIZED SAND BERM AND INCLINED NONMETALLIC GEO-GRID

(71) Applicant: Saudi Arabian Oil Company, Dhahran (SA)

(72) Inventors: Emmanouil Spyropoulos, Dhahran (SA); Hassan A. Alkhalifah, Sayhat (SA); Bassim A. Nawaz, Dammam (SA)

(21) Appl. No.: 17/194,066

(22) Filed: Mar. 5, 2021

(51) Int. Cl. E01F 7/02

(52) U.S. Cl. CPC E01F 7/025

(57) ABSTRACT

An assembly for protecting an area from sand drift accumulation comprises a sand berm having an exposed surface that is chemically stabilized using a stabilizing agent and a fence embedded in the exposed surface of the sand berm at an angle to vertical. The fence deflects wind flow directed toward the sand berm downwards, protecting the area downwind from sand drift accumulation.

### FIELD OF THE DISCLOSURE

The present disclosure relates to systems and methods for mitigating sand movement drift.

### BACKGROUND OF THE DISCLOSURE

Numerous regions, such as the Middle East, have areas that are largely covered with sand dunes. Sand dunes are not static features but rather move, drift or decompose in response to prevailing winds. Inevitably, infrastructure and facilities installed in such areas are subjected to various sand movement and sand drift accumulation problems. Such sand drifts can interfere with and deleteriously affect linear infrastructure, such as roads and pipes as well as “non-linear” infrastructure including gas and oil separation plants. In one investigation recently undertaken of the Applicant's resources, it was found that significant costs are incurred each year for mitigation of sand drifts through mechanical removal. Moreover, mechanical removal is a temporary makeshift since it does not stop dune movement or sand drifts, but merely remediates accumulation that has already occurred.

### SUMMARY OF THE DISCLOSURE

The systems and methods disclosed herein aim at overcoming or significantly mitigating the sand drift problem and reducing interference and damage to infrastructure and facilities located in regions exposed to sand dunes and their attendant mobile drift.

In a first aspect, the present disclosure describes and assembly for protecting an area from sand drift accumulation comprises a sand berm having an exposed surface that is chemically stabilized using a stabilizing agent and a fence embedded in the exposed surface of the sand berm at an angle to vertical. The fence deflects wind flow directed toward the sand berm downwards, protecting the area downwind from sand drift accumulation.

In a further aspect, the present disclosure describes a method of protecting an area from sand drift accumulation. The method comprises erecting a sand berm in positioned adjacent to the area to be protected, the sand berm having an exposed surface that is chemically stabilized using a stabilizing agent and embedding a fence in the exposed surface of the sand berm at an angle to vertical, wherein the fence deflects wind flow directed toward the sand berm downwards, protecting the area downwind from sand drift accumulation.

### BRIEF DESCRIPTION OF THE DRAWINGS

FIG. 1 is a top plan view of an embodiment of a sand berm according to the present disclosure.

FIG. 2A is a cross-sectional view along section A-A of the embodiment shown in FIG. 1.

FIG. 2B is a cross-sectional view along section B-B of the embodiment shown in FIG. 1.

FIG. 3 is a cross-sectional view along section C-C of the embodiment shown in FIG. 1.

### DESCRIPTION OF CERTAIN EMBODIMENTS OF THE DISCLOSURE

The present disclosure describes a system and method for creating a more effective sand barrier. A sand berm, which is a raised bank or ridge comprised of local material is constructed adjacent or near to structures to be protected. In some embodiments, the berm has a trapezoidal shape. The sand berm is then stabilized with chemical polymers so that the berm maintains its geometry and integrity. A fence is installed in the top surface of the berm. The fence is inclined at an angle against the wind flow direction. The combination of the stabilized sand berm and the inclined fence creates a shield that has maximum efficiency in retaining sand particles, particularly on the downwind side of the berm. The sand berm is more effective in preventing sand accumulation than conventional sand fences and much more time and cost-effective than mechanical removal.

FIG. 1 is a schematic top view of a sand berm assembly 100 according to an embodiment of the present disclosure. The sand berm assembly 100 comprises a chemically-stabilized sand berm 110, a raised sand bank or ridge, in which a fence 120 is installed at an angle to the vertical. In the depicted embodiment, the sand berm is trapezoidal in shape, is approximately 7 meters long, and approximately 3 meters high. The sand berm can be made from sandy materials (non-plastic soils) that are available locally either on-site or from off-site. In the depicted embodiment, the top of the berm 112 is flat and is approximately one meter wide and 5 meters long. The sides of the berm 114, 116 are angled with respect to the vertical axis. In the depicted embodiment, the sides 114, 116 are angled at approximately 45 degrees to the vertical. It is noted that these dimensions and angles are exemplary and that the size and shape of the sand berm assembly according to the present disclosure can vary subject to the maximum angle of response of the soil. The angle of repose, or critical angle of repose of a sandy material, is the steepest angle of descent or dip relative to the horizontal plane to which a material can be piled without slumping. The angle of repose is related to the density, surface area and shapes of the particles, and the coefficient of friction of the material. In other words, the berm is constructed so that the slope of the sides of the berm is less than the angle of repose of the soil.

The application of stabilizing agents to the surface of the sand berm 110 creates a hard and durable crust that adheres without considerable sand movement or scattering. The stabilized surface can withstand a range of weather conditions. Additionally, the stabilized sand berm 110 acts as a windbreak assembly at which drag is exerted on the flow and reduces the wind speed in the vicinity.

The chemical stabilizing agents can be polymers such as a styrene/butyl acrylate copolymer which are environmentally friendly compositions designed for sand suppression and can be classified as non-hazardous, non-corrosive and non-toxic. The stabilizing agent can be prepared by mixing the active polymer components in a container having water into which an accurate measure of concentrated polymer is transferred to reach a targeted dilution ratio. The diluted polymer in the container can then be placed under pressure (e.g., using a pump) and then then sprayed onto the sides of the berm using a hose with a nozzle or similar device well known in the art. An exemplary discharge rate for applying the diluted agent that is typically suitable is approximately 500 to 700 Liters/minute, but other rates can be used. The pump head measurement, which is the height from the container source up to the highest point to which the fluid will be pumped typically ranges from approximately 30 meters to approximately 50 meters, although in some applications the pump head can be larger or smaller. The area of the berm sprayed can be divided based on the nature of the worksite and the capacity of the water tank. Dividing the area helps to control and measure the actual spraying rate. The diluted quantity of stabilizing agent is measured against the area to be sprayed per tank. A spray nozzle can be adjusted to even spray the diluted polymer between a jet spray and a mist spray, based on environmental conditions, for example.

When applying (e.g., spraying) the stabilizing agent onto the berm surface certain ambient conditions are preferable. Specifically, it is preferable that there be no precipitation, that the wind speed be no greater than 15 km/h, and that the temperature should be above 20° C. The curing time for the stabilization process is approximately 14 days.

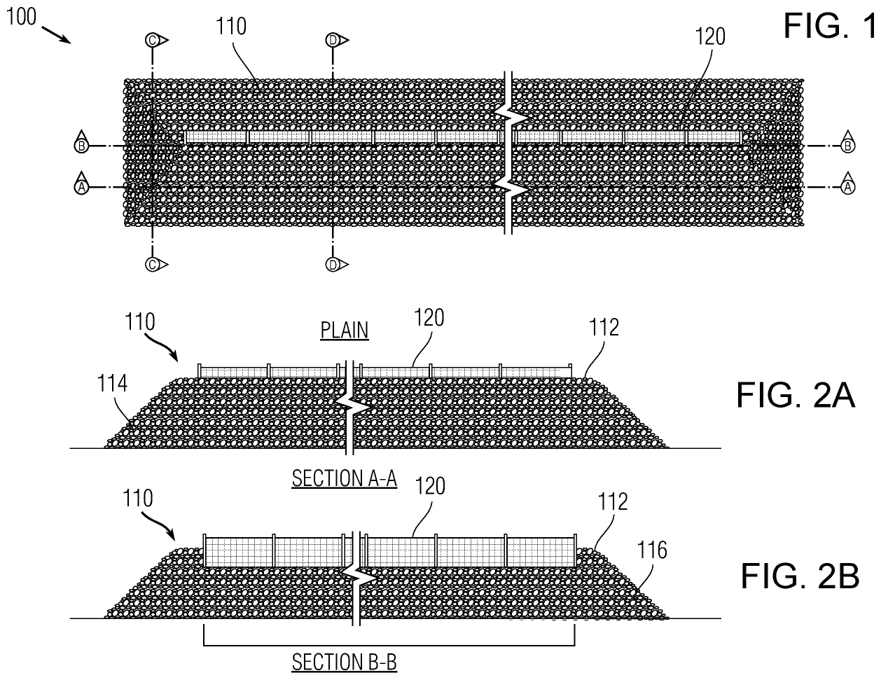

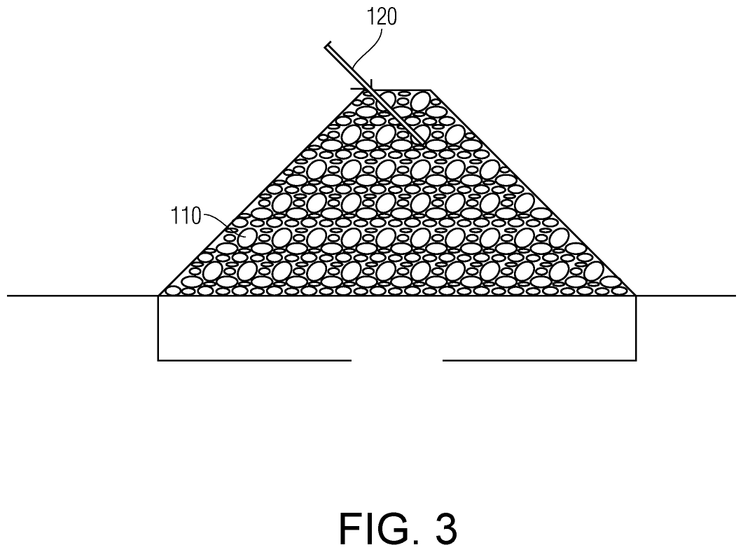

FIGS. 2A and 2B are longitudinal cross-sections that more clearly depict the inclined fence 120 positioned at the top 112 of the sand berm. In some embodiments, the inclined fence can be implemented as a wire net or mesh that extends over the length of the top of the berm. In some embodiments, the fence is made of a non-metallic material such as plastic or other non-metallic material obtained from the refining of crude oil. FIG. 3 is a latitudinal cross-section that more clearly indicates the angle at which the fence 120 extends from the top of the berm 112. In the depicted embodiment, the fence extends at a 45-degree angle from the top of the berm. To provide adequate support, the bottom of the fence is installed 1.2 meters beneath the angled surface 116 of the berm (approximately 2.5 meters above the bottom of the berm). The fence 120, extends 0.8 meters from the angled surface 116 out of the berm 110. Again, the above-listed installation dimensions for the fence are merely exemplary and will vary in different implementations depending upon the size and weight of the fence, among other factors.

The fence 120 acts as a wind shield in that wind flow directed toward the sand berm that reaches the fence is deflected downwards and only a small proportion of particles (less than 20%) passes the whole assembly since the vast majority of sand movement occurs within two meters of the surface. The role of the inclined fence is highly efficient since it traps the incoming windblown sand due to its aerodynamic behavior.

The sand berm according to the present disclosure is constructed in stages. In a first stage, sand and possibly other soil materials is piled and shaped to make an initial berm. This berm is generally about 80 to 90 percent of the height of the final berm. For example, an initial berm of 2.5 meter can be constructed for a 3-meter final target height. In a second stage, a post for the inclined fence (or post of a fence) is installed on the top of the initial berm at an angle. The post can be approximately 2 meters in height. In some embodiments, the post is embedded approximately 0.5 meters into the top of the berm at a 45-degree angle. Preferably the post is approximately 2 meters in height. After installation of the post, backfilling proceeds to increase the height of the berm, while maintaining the same trapezoidal shape. This leaves approximately 0.8 meters of the post exposed. Once the berm has been constructed to a final targeted height, the chemical stabilizing agent is sprayed or otherwise applied to the sloping sides and top of the berm. After the stabilization agent is applied. a mesh, fence or grid is attached to the exposed post as described above to act as a windshield.

However, it is noted that the stabilized sand berm as disclosed herein is intended to be designed in view of a number of factors. Such factors include soil characteristics of the berm, the chemical polymer used for stabilization, dimensions of the berm including height, length, slope and shape, local wind characteristics such as speed, direction, turbulence, structure and thermal stability, terrain characteristics including topographic relief, surface roughness, and sand grain characteristics, and berm placement including the alignment of the berm with regard to the terrain, its location with reference to the facility it protects and the geomorphic unit it controls. The characteristics of the inclined fence including angle, embedded depth of the fence posts, and the section of the fence above ground are an additional set of factors to control to provide optimal protection against sand movement and drift.

Proper design in view of the factors above ensures that the sand berm and fence will act together as barrier against the wing governing flow, and the chemical stabilization of the berm will stabilize the berm from probable soil erosion.

The term “approximately” as used herein in association with a particular nominal value should be taken to mean the value plus a tolerance range of plus and minus five percent of the nominal value. For example, “approximately twenty” (20) should be taken to mean between 19 and 21.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An assembly for protecting an area from sand drift accumulation comprising:
a sand berm having an exposed surface that is chemically stabilized using a stabilizing agent; and
a fence embedded in the exposed surface of the sand berm at an angle to vertical;
wherein the fence deflects wind flow directed toward the sand berm downwards, protecting the area downwind from sand drift accumulation.

2. The assembly of claim 1, wherein the sand berm is trapezoidal in shape, with sloping sides and a flat top surface.

3. (canceled)

4. The assembly of claim 1, wherein the fence is embedded at an angle of between 30 and 60 degrees from vertical.

5. The assembly of claim 4, wherein the fence is embedded at an angle of approximately 45 degrees from vertical.

6. The assembly of claim 1, wherein the fence is made of a non-metallic material.

7. The assembly of claim 1, wherein the stabilizing agent is a styrene/butyl acrylate copolymer.

8. A method of protecting an area from sand drift accumulation:
erecting a sand berm in positioned adjacent to the area to be protected, the sand berm having an exposed surface that is chemically stabilized using a stabilizing agent;
embedding a fence in the exposed surface of the sand berm at an angle to vertical;
wherein the fence deflects wind flow directed toward the sand berm downwards, protecting the area downwind from sand drift accumulation.

9. The method of claim 8, wherein the sand berm is trapezoidal in shape, with sloping sides and a flat top surface.

10. (canceled)

11. The method of claim 8, wherein the fence is embedded at an angle of between 30 and 60 degrees from vertical.

12. The method of claim 11, wherein the fence is embedded at an angle of approximately 45 degrees from vertical.

13. The method of claim 8, wherein the stabilizing agent is a styrene/butyl acrylate copolymer

14. The method of claim 8, wherein the fence is made of a non-metallic material.
